(19) United States
(12) Patent Application Publication
(10) Pub. No.: US 2010/0000492 A1
(43) Pub. Date: Jan. 7, 2010

(54) MODIFIED REVOLVING PISTON INTERNAL COMBUSTION ENGINE

(76) Inventor: Vishvas Prabhakar Ambardekar, Maharashtra (IN)

Correspondence Address: Vishvas P. Ambardekar;SNEHAL, Flat No. 1, Plot No. B-82, Sahakar Nagar No.2, Pune, 411009, IN

(21) Appl. No.: 12/310,122

(22) PCT Filed: Aug. 24, 2006
(86) PCT No.: PCT/IN06/00321

§ 371 Date: Feb. 12, 2009

(51) Int. Cl. F02B 53/00

(52) U.S. Cl. 123/245

(57) ABSTRACT

In a revolving piston device the revolving assemblies are made to complete one or more revolutions for every revolution of the elliptical gears. Port operating ring is used to open the intake passage for the travel of piston pair from TDC to BDC in one revolution of the elliptical gears and to open exhaust passage for the travel of piston pair from BDC to TDC during the next revolution of the elliptical gears. Lower speed of the revolving components induces less vibrations thus gives quite operation. Lower speeds of the elliptical gears allow higher speed of operation for revolving piston device. These types of engines can be used in automobiles, aero industries, marine ships, battlefield tanks, power generation and many other applications. The same concept can also be used to develop a revolving piston compressor or a revolving piston steam engine or a revolving piston two stroke internal combustion engine.

### BACKGROUND

To reduce losses caused by the reciprocating motion of the reciprocating components in a conventional reciprocating piston internal combustion engine, a revolving piston internal combustion engine without a reciprocating component is described by Vishvas P. Ambardekar in the international patent application PCT/IN03/00025, with title “Revolving Piston Internal Combustion Engine” that used a mechanism with two elliptical gears in mesh or a double crank mechanism with some positive drive train, for controlling the relative speed profile of the two revolving assemblies. In the said application, for the revolving piston device with single revolving piston pair, for every revolution of the revolving piston pair the elliptical gears complete two revolutions, thus revolving the elliptical gears at twice the speed of respective revolving pistons or twice the operational speed of the revolving piston device. The present invention is mainly concerned with the reduction of the angular speed of the elliptical gears or of the cranks with respect to the revolving pistons and enhancements for the revolving piston device as stated in international patent application PCT/IN03/00025.

### INTRODUCTION

In the international patent application PCT/IN03/00025, the revolving piston device has fixed inlet and exhaust openings on the fixed circular ring that are connected to the respective manifolds and are operated by the movement of the revolving assemblies itself. For a revolving piston device with single revolving piston pair, the revolving assemblies complete one revolution for every two revolutions of the corresponding two elliptical gears or of the corresponding two cranks. Thus for every revolution of the piston pair, it undergo two cycles of one expansion phase and one compression phase each. In other words the revolving piston pair complete two cycles of their travel from TDC to BDC then again to TDC for its every revolution.

An internal combustion engine working with piston, need four strokes, i.e. intake, compression, power, and exhaust, for its operation, that can be obtained in two cycles of one expansion and one compression phases each. As the elliptical gears or the cranks of the relative speed profile controlling mechanism give one cycle of one expansion and one compression phase each, for it's every revolution, it is possible to complete the two cycles of the two phases each within two or more revolutions of the revolving piston pair.

In the present work on enhancements for the revolving piston device, some mechanism is introduced to operate the intake and exhaust ports appropriately to allow the revolving piston pair to revolve for more than one revolution to complete the two cycles of the two phases each.

In a revolving piston device, the reduction in the rotational speeds of revolving components, with respect to the revolving pistons, facilitates the revolving piston device to be operated at higher operational speeds of revolving pistons. This reduction in the speed of revolutions of the elliptical gears or of the cranks can make a revolving piston device more compact with reduced vibrations and reduced problems of balancing the components that are having eccentric loading.

Revolving piston device with only one pair of revolving pistons associated with the fixed circular ring and that uses two elliptical gears in mesh or a double crank mechanism for controlling the relative speed profile of the two revolving pistons is discussed here with the help of few drawings. On the same principle a revolving piston device can be made without much difficulty, to have more number of revolving piston pairs. This type of revolving piston devices can be used to make internal combustion engines that can be used in automobiles, electric power generation, aero industries, marine ships, battlefield tanks, and in many other applications. The same concept, with appropriate design changes, can be used to develop a revolving piston air compressor or a hydraulic pump.

### DEFINITIONS

Revolving Speed Ratio (RSR): In a revolving piston device, RSR is the ratio, without considering the direction of rotation, of the instantaneous speed of revolution of the revolving piston to that of the corresponding elliptical gear OR corresponding crank of the mechanism that controls the relative speed profile of the revolving pistons. Maximum obtainable RSR for a revolving piston device can give maximum separation between two revolving pistons of a revolving piston pair. For a revolving piston device with single revolving piston pair, RSR should preferably be an integer value more than or equal to unity, as for RSR being a fractional number greater than unity, the zones of the fixed circular ring in which expansion and compression of the controlled active volume take place, will not be fixed and thus will pose difficulty in locating the openings for intake and exhaust on the fixed circular ring.

For a revolving piston device with single piston pair as described in international patent application PCT/IN03/00025, the RSR value is 0.5. For the revolving piston devices that have single revolving piston pair and have RSR less than or equal to 0.5, the intake and exhaust passages can be operated by the movement of the revolving pistons itself, as the revolving piston pair can complete the four strokes within one revolution and thus some fixed zones on the fixed circular ring can be found that can always act for intake or exhaust openings whenever the controlled active volume is present in that zone. For revolving piston devices with single revolving piston pair and RSR less than unity, it is preferable to have integer value of the reciprocal of RSR so as to have fixed zones for the intake and exhaust openings or ports on the fixed circular ring.

Controlled Active Volume (CAV): The volume trapped between the two revolving pistons of a revolving piston pair is called the controlled active volume however as the pistons are revolving, from time to time the space between the revolving pistons of a piston pair is enclosed by other engine components also. While the pistons revolve, the variation in the CAV is utilised for various strokes for example, intake, compression, power or expansion and exhaust strokes appropriately. The CAV is at its minimum when the two pistons of a revolving piston pair are at TDC.

Top Dead Centre (TDC): In a reciprocating piston device, when the piston is at its inner most position inside the cylinder and has minimum distance from the cylinder head, the piston is called to be at its TDC and has zero instantaneous speed with respect to the cylinder head and it reverses the direction of its motion. Equivalent to this, for a revolving piston device the TDC is the state when the pistons of a revolving piston pair are closest to each other, any further movement of the pistons take them away from each other. In a revolving piston device this state is the end of compression and start of expansion phase of the CAV. At TDC the relative speed between the two revolving pistons of a revolving piston pair is zero as both the pistons of a revolving piston pair have same instantaneous speed of revolution.

Bottom Dead Centre (BDC): In a reciprocating piston device, when the piston is at its outer most position inside the cylinder and has maximum distance from the cylinder head, the piston is called to be at its BDC and has zero speed with respect to the cylinder head and it reverses the direction of its motion. Equivalent to this, for a revolving piston device the BDC is the state when the pistons of a revolving piston pair are farthest from each other, any further movement of the pistons bring them towards each other. In a revolving piston device this state is the end of expansion and start of compression phase of the CAV. At BDC the relative speed between the two revolving pistons of a revolving piston pair is zero as both the pistons of a revolving piston pair have same instantaneous speed of revolution.

### NOMENCLATURE FOR DRAWING SHEETS

FIG. 1: Schematic representation of a revolving piston device for a configuration with single revolving piston pair that is at TDC with RSR as 1 displaying typical locations of the various openings for inlet and exhaust passages on different components. The port operating ring is shown outside the fixed circular ring. The two elliptical gears are having instantaneous speed ratio of 1:1. The two pitch ellipses are touching each other at the respective extremities of their minor axis.

FIG. 2: The schematic revolving piston device with configuration as shown in FIG. 1 displaying its revolving pistons at mid way of their travel from TDC to BDC. The revolving piston pair is mid way of the expansion phase. The leading piston is revolving at its maximum speed with respect to the trailing piston. The two pitch ellipses touch each other at the respective extremities of their major axis.

FIG. 3: The schematic revolving piston device with configuration as shown in FIG. 1 displaying its revolving piston pair at BDC. The two elliptical gears are having instantaneous speed ratio of 1:1. The two pitch ellipses are touching each other at the respective extremities of their minor axis.

FIG. 4: The schematic revolving piston device with configuration as shown in FIG. 1 displaying its revolving pistons at mid way of their travel from BDC to TDC. The revolving piston pair is mid way of the compression phase. The leading piston is revolving at its minimum speed with respect to the trailing piston. The two pitch ellipses are touching each other at the respective extremities of their major axis.

FIG. 5: Schematic representation of a revolving piston device for a configuration with single revolving piston pair that is at TDC with RSR as 2 displaying typical locations of the various openings for inlet and exhaust passages on different components. The port operating ring is shown outside the fixed circular ring. The two elliptical gears are having instantaneous speed ratio of 1:1. The two pitch ellipses are touching each other at the respective extremities of their minor axis.

FIG. 6: The schematic revolving piston device with configuration as shown in FIG. 5 displaying its revolving pistons at mid way of their travel from TDC to BDC. The revolving piston pair is mid way of expansion Phase. The leading piston is revolving at its maximum speed with respect to the trailing piston. The two pitch ellipses are touching each other at the respective extremities of their major axis.

FIG. 7: The schematic revolving piston device with configuration as shown in FIG. 5 displaying its revolving piston pair at BDC. The two elliptical gears are having instantaneous speed ratio of 1:1. The two pitch ellipses are touching each other at the respective extremities of their minor axis.

FIG. 8: The schematic revolving piston device with configuration as shown in FIG. 5 displaying its revolving pistons at mid way of their travel from BDC to TDC. The revolving piston pair is mid way of compression phase. The leading piston is revolving at its minimum speed with respect to the trailing piston. The two pitch ellipses are touching each other at the respective extremities of their major axis.

FIG. 9: View of a typical port operating ring displaying the openings for the intake and exhaust passages for the revolving piston device configuration as shown in FIG. 1.

FIG. 10: View of a typical port operating ring displaying the openings for the intake and exhaust passages for the revolving piston device configuration as shown in FIG. 5.

FIG. 11: Cross sectional view of the port operating ring in FIG. 9 at A-A.

FIG. 12: Cross sectional view of the port operating ring in FIG. 10 at B-B.

FIG. 13: Schematic representation of a revolving piston device similar to that in FIG. 1, for a configuration with single revolving piston pair that is at TDC with RSR as 1 except for that the arrangement of the port operating ring is inside the fixed circular ring. Typical locations of the openings for inlet and exhaust passages on fixed circular ring, on port operating ring, and on the respective manifolds are also displayed.

FIG. 14: Schematic representation of a revolving piston device similar to that in FIG. 5, for a configuration with single revolving piston pair that is at TDC with RSR as 2 except for that the arrangement of the port operating ring is inside the fixed circular ring. Typical locations of the openings for inlet and exhaust passages on fixed circular ring, on port operating ring, and on the respective manifolds are also displayed.

FIG. 15: Schematic representation of a revolving piston device for a configuration with RSR as 1 and with single revolving piston pair that is at TDC, similar to that shown in FIG. 1 except for, that a typical double crank mechanism is used for controlling the relative speed profile of the two revolving pistons, instead of two elliptical gears in mesh. The port operating ring is shown outside the fixed circular ring. Typical locations of the openings for inlet and exhaust passages on fixed circular ring, on port operating ring, and on the respective manifolds are also displayed. The two cranks are having instantaneous speed ratio of 1:1.

### MAIN COMPONENTS OF THE REVOLVING PISTON DEVICE

Revolving piston device with only one revolving piston pair is discussed in present work and consists of following major components:

1. Revolving Piston Device Main Assembly: This consists of mainly one fixed circular ring, intake and exhaust manifolds, and two revolving assemblies with at least one revolving piston pair. The components are described below:

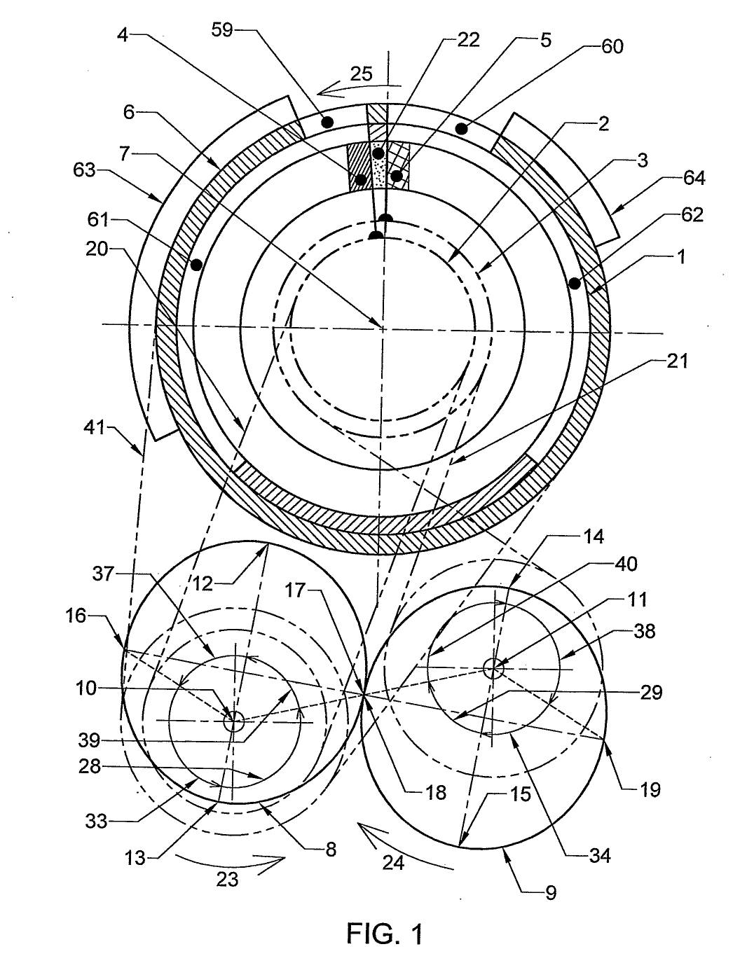

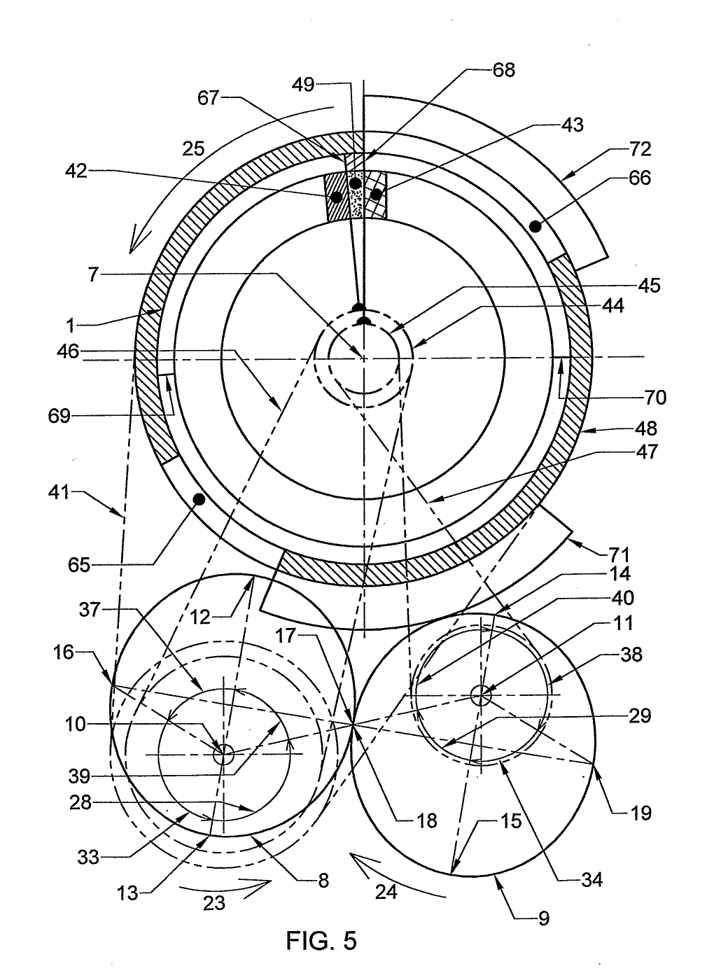

Fixed Circular Ring: This is a fixed circular ring of any suitable cross-section as represented by 1 in FIG. 1 and FIG. 5. The axis of the fixed circular ring is called the common axis and is used as axis of revolution for many components of the revolving piston device. This fixed circular ring forms a fixed member for the revolving piston device. This part may be made of many parts joined together. The fixed circular ring has openings for intake and exhaust passages.

Intake and Exhaust Manifolds: The intake and exhaust manifolds are also fixed members and are connected to the fixed circular ring. The respective manifolds have openings for inlet and exhaust passages. The port operating ring revolves around the common axis and is placed either inside the fixed circular ring or in the space between the openings on manifolds and on the fixed circular ring. The manifold and the fixed circular ring together provide sealing and support to the port operating ring.

Revolving Assemblies: Revolving piston device has two revolving assemblies, which are represented by 2 and 3 in FIG. 1 and by 44 and 45 in FIG. 5. The two revolving assemblies revolve in same direction around the common axis and are coupled to each other through a mechanism that governs their relative angular speed profile. These two revolving assemblies almost simultaneously complete one cycle of two phases that consists of one expansion phase and one compression phase. The number of revolutions of the two revolving assemblies per cycle of two phases depends upon the RSR value, number of revolving piston pairs associated with one fixed circular ring. These two revolving assemblies are attached with one ring gear each that can either have internal or external teeth as to help transfer of motion without slip from the mechanism that regulates the relative angular speed profile to the two assemblies. These ring gears can be replaced with chain wheels or timing pulleys or some other positive motion transfer devices that can appropriately be used for the same purpose. These ring gears may belong to the positive drive train that transfers the motion from the relative speed profile generator to the revolving assemblies. One of the revolving assemblies with less variation in the rotational speed as compared to the other revolving assembly is more suitable to connect to a flywheel. An output shaft is suitably connected to or suitably coupled to one of the revolving assemblies. The axis of the output shaft need not necessarily coincide with the common axis.

Revolving Piston Pair: A portion of individual revolving assembly as discussed above is specially designed to act as a revolving piston. Such two revolving pistons, one from each revolving assembly, form a revolving piston pair. One piston of the revolving piston pair is called leading piston and other is called trailing piston. At least one revolving piston pair is associated with one fixed circular ring. More revolving piston pairs can exist per fixed circular ring. In FIG. 1 the leading and trailing pistons of revolving piston pair are represented by 4 and 5 respectively, and are portions of revolving assemblies 2 and 3 respectively. Volume or the space between the revolving pistons of a revolving piston pair undergoes controlled variation as a result of relatively varying angular speeds of the revolving pistons and is used as CAV.

### 2. Mechanism for Controlling the Relative Speed Profile of the Two Revolving Assemblies:

This mechanism is very important component of the revolving piston device and governs the instantaneous speed of revolution of one revolving assembly with respect to that of the other revolving assembly. The mechanism consists of a relative speed profile generator hereafter called as profile generator and a combination of positive drives. Combination of positive drives is here after called as positive drive train.

Profile generator is made up of two meshing elliptical gears, with identical pitch ellipses, arranged in such a way that their pitch ellipses roll over each other. The fixed axes of rotations of the two elliptical gears pass through the geometric focus point of respective pitch ellipses and the distance between them is equal to the length of the major axis of the pitch ellipse. The relative speed profile is the variation in the ratio of instantaneous angular speed of one elliptical gear with respect to that of other elliptical gear and is symmetrical in shape.

The profile generator can also be made up of a four bar linkage working as a double crank mechanism, with the two cranks revolving around fixed axes. The relative speed profile is the variation in the ratio of instantaneous angular speed of one crank with respect to that of other crank. The shape of the relative speed profile generated depends upon the ratio of the lengths of links used to form the double crank mechanism thus can be typically used for getting fast compression and slow expansion or vice versa in other words, for getting unequal revolutions of CAV for TDC to BDC and for BDC to TDC.

The profile generator with two elliptical gears in mesh, as mentioned above, is equivalent of a typical double crank mechanism that has opposite links of equal length; a situation kinematically known as dead-centre position occur when the four links become collinear; the meshing teeth on the elliptical gears avoid the possibility of reversal of direction of a crank rotation at dead-centre position.

One cycle of revolutions for the revolving assemblies of a revolving piston device with single revolving piston pair is completed with one and two revolutions of either the elliptical gears or the cranks of the profile generator, for a revolving piston device respectively working as a compressor and as an internal combustion engine.

Angular motion of the two components of the profile generator i.e. two elliptical gears or the two cranks, is transferred to the two revolving assemblies without slip and with desired RSR through the positive drive train, in such a way that both the revolving assemblies revolve in same direction.

3. Mechanism to operate the intake and exhaust ports: For a revolving piston device with single piston pair and with RSR as 0.5 or less, the fixed circular ring can have openings in certain fixed zones that can always be utilised as ports for intake and exhaust, whenever the CAV is within the respective zones. Thus no additional mechanism is needed for controlling the intake and exhaust passages as the passages can be controlled by the motion of the revolving pistons itself, by providing appropriate openings on the revolving assemblies within the zone of clearance volume, in such a way that the absence of CAV within the zone of the fixed circular ring make the respective port closed. This is achieved by providing appropriate openings, on the fixed circular ring and on the revolving assemblies.

For a revolving piston device with single piston pair and RSR as one or more, on the fixed circular ring no fixed zones can be found that can always be utilised as a port whenever CAV is present within the zone; a zone on the fixed circular ring that can be opened for intake passage in one revolution of the elliptical gear, must be closed during the next revolution, being a zone for expansion chamber. Similarly a zone on the fixed circular ring that can be opened for exhaust passage in one revolution of the elliptical gear must be closed, being a zone for compression phase during the next revolution. For RSR as 1, for every revolution of elliptical gears, revolving assemblies complete one revolution it means for every revolution of the revolving assemblies the piston pair undergoes only one expansion and one compression phase. An appropriate opening on the fixed circular ring within a zone in which the piston pair undergoes expansion phase can be used for intake in one revolution but in next revolution this opening must be closed as the piston pair utilises the expansion phase as the power stroke within the same zone of the fixed circular ring. Similarly an opening that can be used for exhaust port on the fixed circular ring has to be closed in one revolution and has to be opened in the next revolution. This appropriate opening and closing of the ports is not possible just by movement of the revolving assemblies. Thus an additional mechanism is needed for controlling the intake and exhaust passages in a revolving piston device with single revolving piston pair and with RSR as one or more.

This additional mechanism can be a simple revolving ring 6, as shown in FIG. 1, thus can be called as port operating ring, with appropriate openings for intake and exhaust passages. This port operating ring revolves around the common axis and is coupled through some positive drive train to appropriate revolving component of the revolving piston device. The main objective of the port operating ring is to open and close the respective passages from the intake and the exhaust manifolds through the openings on the fixed circular ring to the CAV for respective specified travels of the revolving piston pair and for the same the port operating ring is synchronized with appropriate revolving component of the revolving piston device. Both passages for intake and exhaust can be controlled by a common port operating ring or separate port operating rings can be used for controlling the respective individual passages.

The fixed circular ring, the respective manifolds, the revolving assemblies, and the port operating ring all are to be specifically designed with appropriate openings in such a way that the opening and closing of the respective passages is appropriately synchronized with the respective travel of the revolving piston pair.

### Principle of Operation:

Only the revolving piston devices with RSR as 1 and 2, with single revolving piston pair, that uses two meshing elliptical gears as the profile generator are discussed here. The double crank mechanism can easily be used for the profile generator in place of the two meshing elliptical gears with appropriate design changes in the components of the revolving piston device.

One revolution of the respective elliptical gears is needed for obtaining one expansion phase and one compression phase of the CAV. While using the revolving piston device as internal combustion engine, in one revolution of the elliptical gear, the expansion phase and compression phase of the CAV are used for intake and compression strokes during the travel of the piston pair from TDC to BDC and then from BDC to TDC respectively. In the next revolution of the elliptical gear the two phases of CAV are used for power and exhaust strokes for the travel of piston pair from TDC to BDC and then from BDC to TDC respectively. The piston pair revolves for one or more than one revolutions for every revolution of the elliptical gear depending on the RSR value for the revolving piston device. Thus for the cycle of four phases, the intake passage from intake manifold to CAV is to be opened for the first expansion phase for intake stroke, then both intake and exhaust passages are to be closed for the first compression phase and second expansion phase for compression stroke and power stroke respectively, then for the second compression phase the exhaust passage is to be opened from CAV to exhaust manifold for exhaust stroke.

Two configurations are considered here for describing the generation of various strokes, closing, and opening of intake and exhaust passages for a single revolving piston pair-internal combustion engine.

Configuration 1: This configuration is shown in FIG. 1 with the RSR value as 1. The fixed common axis is represented by 7. The two meshing elliptical gears of the profile generator are represented by 8 and 9. For simplicity only the pitch ellipses are shown that are identical for both the respective elliptical gears. 10 and 11 are the fixed axes of rotation of the two elliptical gears and are passing through one of the geometric foci of the respective pitch ellipses and have the distance between them equal to the length of the major axis of the pitch ellipse. Line segments connecting 12, 13 and 14, 15 are the major axes and line segments connecting 16, 17 and 18, 19 are the minor axes for the two pitch ellipses respectively. Two positive drive trains are represented by 20 and 21 that are used to transfer the rotary motion of the two elliptical gears 8 and 9 to the two revolving pistons 4 and 5 that are the portions of revolving assemblies 2 and 3 respectively, in such a way that both the pistons revolve in the same direction and maintain the same rotational speeds as that of the two elliptical gears respectively.

FIG. 1 shows the position of elliptical gears 8 and 9 with the instantaneous speed ratio of 1:1 between them, with the minor axes ends 17 and 18 of the respective pitch ellipses touching each other. The leading and trailing revolving pistons of the revolving piston pair are at positions 4 and 5 respectively at TDC and thus 22 the CAV between them is at the minimum and can be called as clearance volume. Arrows 23, 24 and 25 show the direction of rotation of individual elliptical gears and the revolving assemblies.

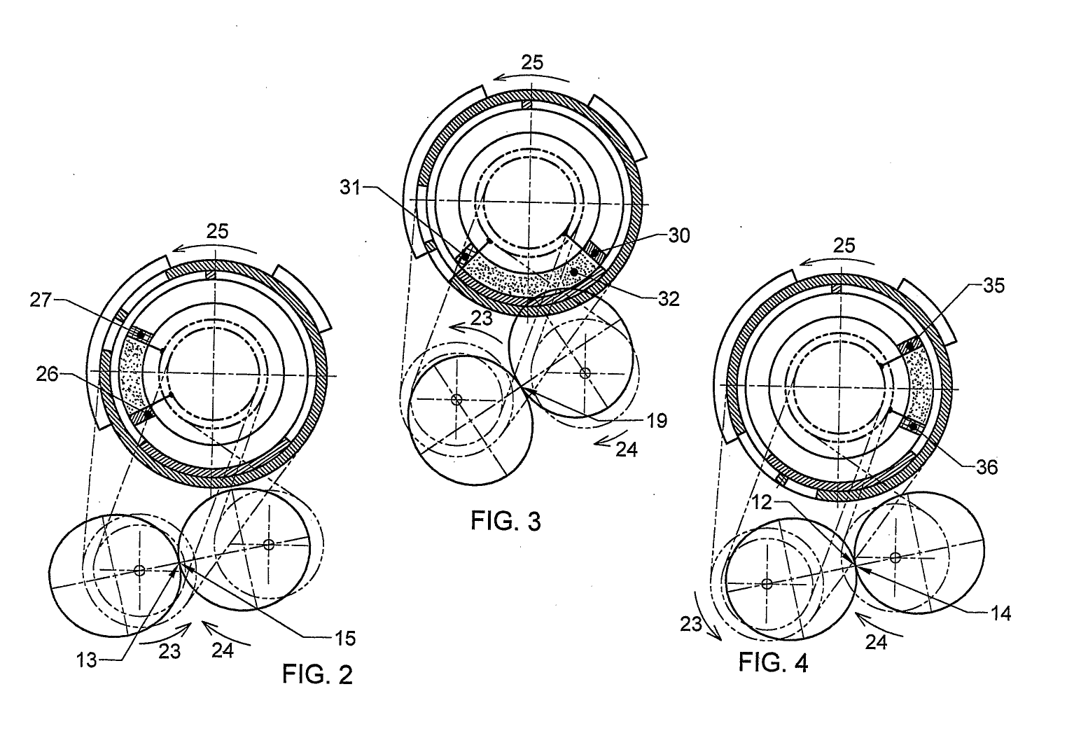

As the two elliptical gears rotate in the directions 23 and 24 and the piston pair moves past TDC, the leading piston moves faster than the trailing one and thus the revolving pistons relatively move away from each other thus the expansion phase begins. As elliptical gears have rotated through angles 28 and 29 respectively, pitch ellipses touch each other at the extremities 13 and 15 of their respective major axes; instantaneous speed ratio between them is at maximum; the leading and trailing revolving pistons are at mid way to their travel from TDC to BDC as shown in FIG. 2, and are at their new positions 26, 27 respectively.

Continued rotation of the two elliptical gears in the direction 23, 24, further take the leading and trailing pistons away from each other until they reach at BDC and are at positions 30, 31 as shown in FIG. 3. At BDC, 32 the CAV is at its maximum and the expansion phase ends. As elliptical gears have rotated through angles 33 and 34 respectively, pitch ellipses touch each other at the extremities 16 and 19 of their respective minor axes; instantaneous speed ratio between them becomes 1:1.

The leading and trailing pistons now move closer with respect to each other as the two elliptical gears continue to rotate in the directions 23, 24 respectively; the compression phase begins. The leading and trailing revolving pistons are at mid way of their travel from BDC to TDC with their respective new positions 35, 36 as shown in FIG. 4. As elliptical gears have rotated through angles 37 and 38 respectively, pitch ellipses touch each other at the extremities 12 and 14 of their respective major axes; instantaneous speed ratio between them is at minimum. Further rotation of the two elliptical gears in the direction 23, 24 bring the leading and trailing pistons further closer to each other. As elliptical gears have rotated through angles 39 and 40 respectively, pitch ellipses touch each other at the extremities 17, 18 of their respective minor axes; instantaneous speed ratio between them becomes 1:1; the revolving pistons are again at TDC as shown in FIG. 1; the compression phase ends.

Thus for revolving pistons motion from TDC to BDC as sequentially shown in FIG. 1, FIG. 2 and FIG. 3, CAV undergoes through expansion phase similarly for revolving pistons motion from BDC to TDC as sequentially shown in FIG. 3, FIG. 4 and FIG. 1, CAV undergoes through compression phase. These expansion and compression phases of the CAV are used as intake stroke and compression stroke in one revolution of the revolving piston pair corresponding to one revolution of the elliptical gears and power stroke and exhaust stroke in the next revolution of the revolving piston pair corresponding to next revolution of the elliptical gears. Thus for every two revolutions of the revolving pistons pair, the four strokes that are needed for the functioning of internal combustion engine are completed.

During one revolution of the piston pair the passage from intake manifold to the CAV is open for the travel of trailing piston from position 5 at TDC to its position 31 at BDC, as to fill CAV with air or air fuel mixture; both the passages for intake and exhaust are closed for the travel of the piston pair from BDC to TDC as to avoid loss of the contents of the CAV during its compression stroke. The ignition takes place appropriately when the piston pair is at TDC or near to TDC that leads to the combustion inside the CAV which follows the expansion of CAV for the travel of piston pair from TDC to BDC during next revolution of the revolving piston pair, for which both the passages for intake and exhaust are closed. For further travel of the revolving piston pair from BDC to TDC i.e. the travel of leading piston from its position 30 at BDC to its position 4 at TDC, the exhaust passage from the CAV to the exhaust manifold is opened to remove the products of combustion. Thus for every two revolutions of the revolving piston pair the intake and exhaust passages open only once for the specific travel of the piston pair as stated above, for rest of the time during the two revolutions cycle the passages are closed. This opening and closing of the individual passages for every two revolutions of the revolving piston pair, as explained above, is performed by the appropriate openings provided on the port operating ring during its every revolution, corresponding to every two revolutions of the two elliptical gears or the two cranks of the profile generator. FIG. 1 displays schematic port operating ring 6 that is coupled to elliptical gear 8 through positive drive train 41.

Configuration 2: This configuration is shown in FIG. 5 with the RSR value as 2. Consider the same profile generator as used in configuration 1. Revolving pistons complete two revolutions for every revolution of the respective elliptical gear. Referring to the FIG. 5, common identification numbers represent same object as shown in the FIG. 1. In FIG. 5, the leading and trailing revolving pistons of revolving piston pair are represented by 42 and 43 at TDC respectively, and are portions of revolving assemblies 44 and 45 respectively. Two positive drive trains 46 and 47 are used to couple the revolving assemblies 44 and 45 to the elliptical gears 8 and 9 of the profile generator respectively in such a way that both the revolving assemblies revolve in same direction and complete two revolutions for every revolution of the respective elliptical gear. FIG. 5 displays schematic port operating ring 48 as coupled to elliptical gear 8 through positive drive train 41.

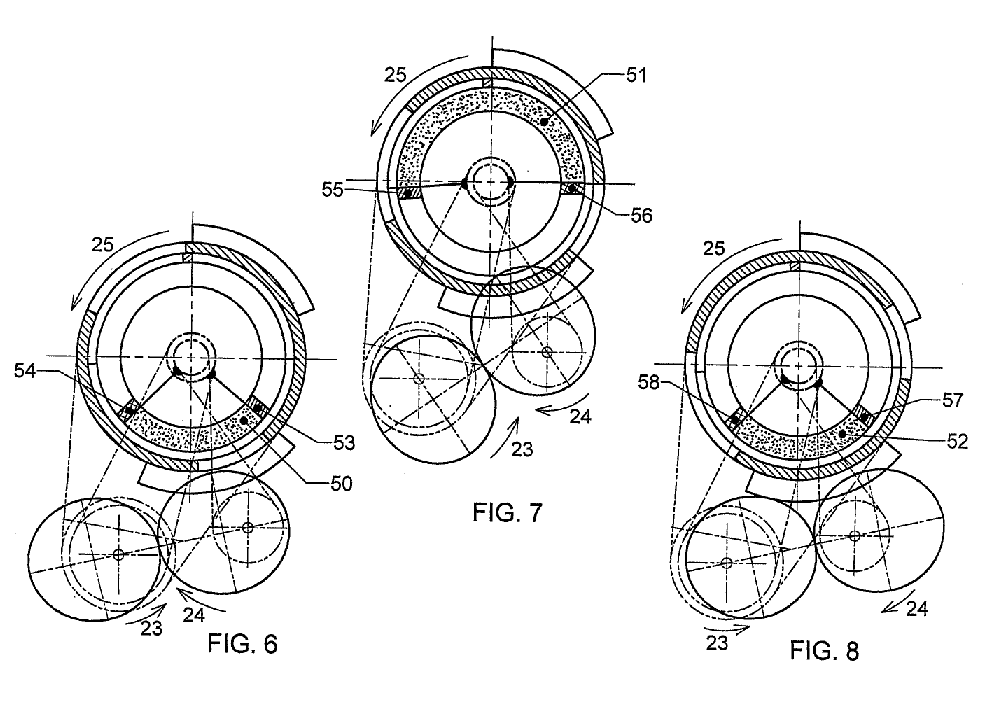

Sequentially FIG. 5 to FIG. 8 show the positions of the engaged elliptical gears, similar to that for configuration 1, corresponding to the revolving piston pair at TDC, at midway from TDC to BDC, at BDC and at midway from BDC to TDC respectively; respective positions of CAV are represented by 49, 50, 51 and 52. Corresponding positions of the leading and trailing pistons are 42, 43 at TDC; 53, 54 at midway of TDC to BDC; 55, 56 at BDC and 57, 58 at mid way of BDC to TDC.

Thus it can be seen that with RSR as 2 revolving pistons complete two revolutions for every revolution of the elliptical gears or of the cranks of the profile generator. Thus the elliptical gears complete a cycle of two revolutions for four revolutions of the revolving piston pair. In configuration 2 the opening and closing of the individual passages and the ignition take place similar to that in configuration 1 with respect to the TDC and BDC positions of the leading and trailing pistons of the revolving piston pair, except that in configuration 2 the revolving piston pair complete two revolutions for the travel from TDC to BDC and again to TDC as against correspondingly one revolution in configuration 1.

Thus for every four revolutions of the revolving piston pair the intake and exhaust passages open only once for specific travel of the piston pair as stated above, for rest of the time during the four revolutions cycle the respective passages are closed. This opening and closing of the individual passages for every four revolutions of the revolving piston pair, as explained above, is performed by the appropriate openings provided on the port operating ring during its every revolution, corresponding to every two revolutions of the two elliptical gears.

### Principle of Operation of the Port Operating Ring:

For explaining the function of the port operating ring, operation of configuration 1 and configuration 2 of the revolving piston device is considered separately. In the description the elliptical gears can be replaced with a suitable double crank mechanism for the profile generator with appropriate design changes in the revolving piston device.

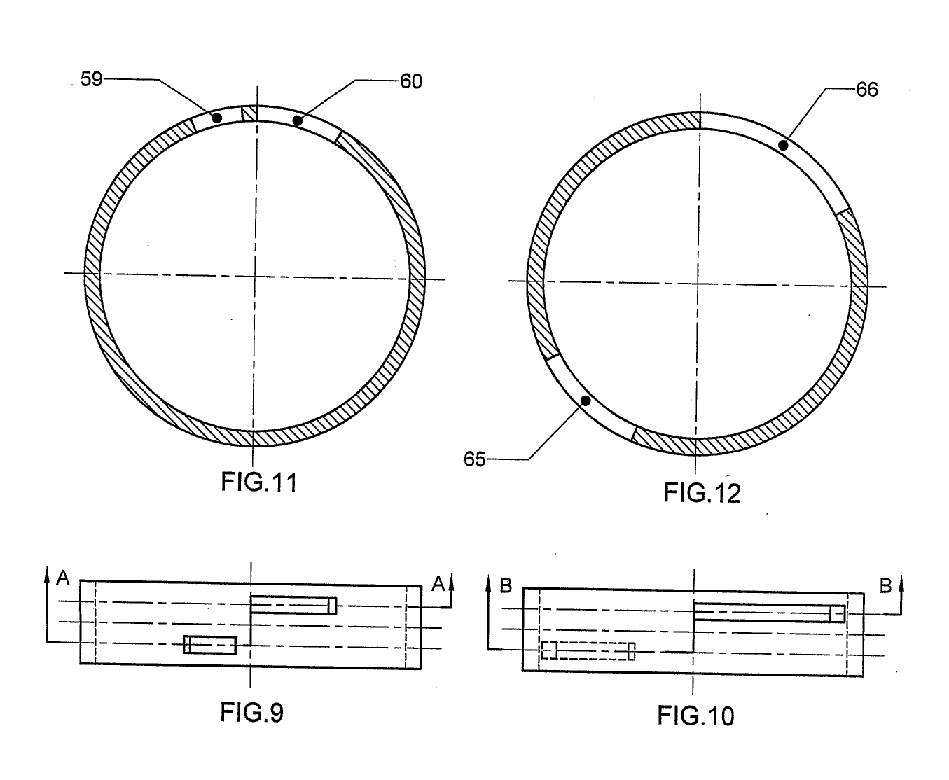

Configuration 1: FIG. 9 shows a typical schematic port operating ring that is used for configuration 1 with RSR as 1 with a cross-sectional view at A-A as shown in FIG. 11 and is represented by 6 in FIG. 1. The port operating ring has opening 59 for intake passage and opening 60 for exhaust passage. The port operating, ring is coupled to the elliptical gear 8 through a positive drive train 41 such that it revolves in the direction of revolution of the revolving assemblies and completes one revolution for every two revolutions of the elliptical gears in other words the speed ratio between the port operating ring and elliptical gear is 1:2.

Two separate openings, not shown, one on each of the two revolving assemblies are provided within the zone of clearance volume and are extended up to the inner faces of the two pistons of the revolving piston pair when at TDC; the opening for the intake passage is provided on the revolving assembly 3 that has its portion working as trailing piston and the opening for the exhaust passage is provided on the revolving assembly 2 that has its portion working as leading piston.

Fixed circular ring is provided with opening 61 for intake passage that is extended from inner face of the leading piston position 4 at TDC to the inner face of the trailing piston position 31 at BDC, and opening 62 for exhaust passage that is extended from inner face of the leading piston position 30 at BDC to the inner face of the trailing piston position 5 at TDC. Suitable openings within zones 63 and 64 are provided for intake and exhaust passages on respective manifolds.

When an opening, fully or partially, comes within the zone of other opening, the passage between the two openings is opened. Thus it is necessary that an opening on the revolving assemblies should be within zone of intake opening 61 on the fixed circular ring and the intake opening 59 on the port operating ring should be within the zones of the intake openings 61 and 63 on the fixed circular ring and on the intake manifold respectively for opening the passage from the intake manifold to the CAV. Similarly it is necessary that an opening on the revolving assemblies should be within the zone of exhaust opening 62 on the fixed circular ring and the exhaust opening 60 on the port operating ring should be within the zones of exhaust openings 62 and 64 on the fixed circular ring and on the exhaust manifold respectively for opening passage from the CAV to the exhaust manifold.

It can be seen from the FIG. 1 that during first revolution of the revolving piston pair starting from the state as shown in FIG. 1, as the pistons revolve from TDC to BDC the port operating ring also revolve and the necessary condition for opening a passage as stated above is satisfied only for the intake passage throughout the travel of the piston pair from the TDC to BDC. Similarly the necessary condition for opening a passage is satisfied only for the exhaust passage for the travel of the piston pair from BDC to TDC during the next revolution of the revolving piston pair. For rest of the travel during the two revolutions of the revolving piston pair, the necessary condition for opening of a passage is not satisfied for either of the intake and exhaust passages. Thus it can be seen that the revolution of the port operating ring 6 as coupled with speed ratio of 1:2 to the elliptical gear 8 can close and open the intake and exhaust passages as desired for the revolving piston device to work as an internal combustion engine.

Configuration 2: FIG. 10 shows a typical schematic port operating ring that is used for configuration 2 with RSR as 2 with a cross-sectional view at B-B as shown in FIG. 12 and is represented by 48 in FIG. 5. Openings 65 and 66 are the openings in the port operating ring 48 for intake and exhaust passages respectively. The port operating ring is coupled to the elliptical gear 8 trough a positive drive train 41 such that it revolves in the direction of revolution of the revolving assemblies and completes one revolution for every two revolutions of the elliptical gear in other words the speed ratio between the port operating ring and elliptical gear is 1:2.

Openings for intake and exhaust on the revolving assemblies are similar to that provided for configuration 1 and can be described with appropriate replacement, of the item number 2 and 3 with item number 44 and 45 for the respective revolving assemblies corresponding to the leading and trailing pistons, in the description as described for configuration 1.

Opening in the fixed circular ring for the intake passage is extended in counter clockwise direction from 67, the position of inner face of the leading piston 42 at TDC, to 70, the position of inner face of the trailing piston 56 at BDC; similarly the opening for the exhaust passage is extended in counter clockwise direction from 69, the position of inner face of the leading piston 55 at BDC to 68, the position of inner face of the trailing piston 43 at TDC. Zones for openings for the passages on intake and exhaust manifolds are represented by 71 and 72 respectively.

The necessary condition for opening of respective passage is similar to that stated before in configuration 1. Thus the necessary condition for opening passage from the intake manifold to the CAV is that, that an opening on the revolving assemblies should be within zone of intake opening on the fixed circular ring and the intake opening 65 on the port operating ring should be within the zones of the intake openings on the fixed circular ring and on the intake manifold. Similarly the necessary condition for opening passage from the CAV to the exhaust manifold is that, that an opening on the revolving assemblies should be within zone of exhaust opening on the fixed circular ring and the exhaust opening 66 on the port operating ring should be within the zones of the exhaust openings on the fixed circular ring and on the exhaust manifold.

It can be seen from FIG. 5 that in configuration 2, while the revolving assemblies and the port operating ring are revolving about the common axis as controlled by the revolution of elliptical gears the necessary condition for opening of the intake port is satisfied only for the travel of the piston pair from TDC to BDC during the first cycle of two revolutions of the revolving piston pair. Similarly the exhaust passage is open only during the travel of the revolving piston pair from BDC to TDC during the next cycle of two revolutions of the revolving piston pair. For rest of the revolutions in a cycle of four revolutions of the revolving assemblies or two revolutions of the respective elliptical gears, the necessary condition for opening of a passage is not satisfied for either of the intake and exhaust passages and thus the passages are closed. Thus it can be seen from FIG. 5 that the revolution of the port operating ring 48 as coupled with speed ratio of 1:2 to the elliptical gear 8 can close and open the intake and exhaust passages as desired for the revolving piston device to work as an internal combustion engine.

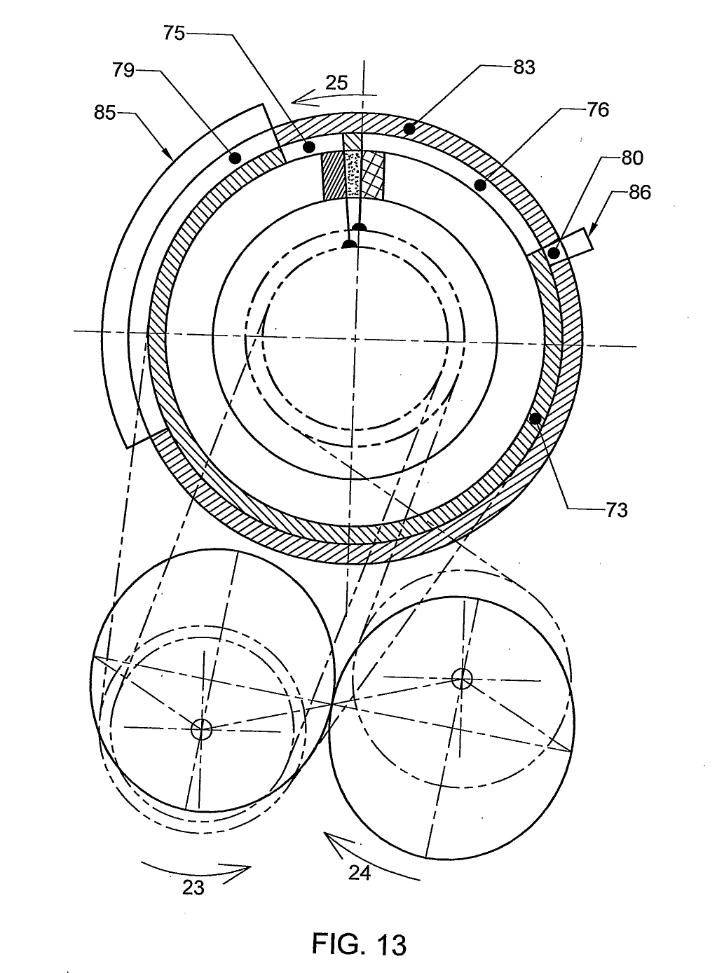

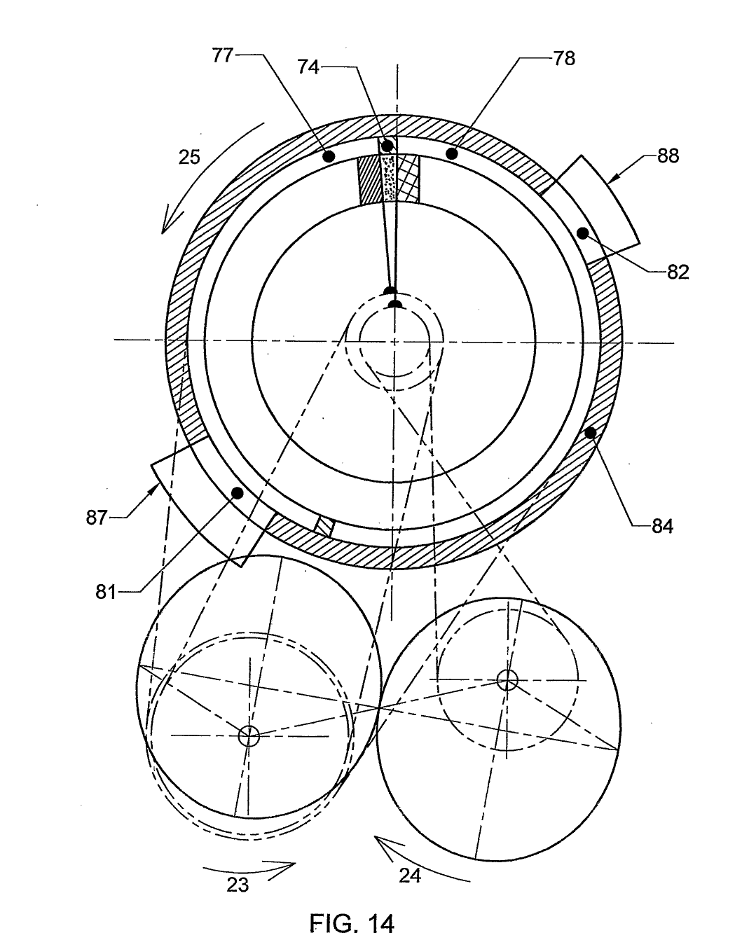

The above description for the operation of port operating ring for the configurations 1 and 2 explains a port operating ring located outside the fixed circular ring and inside the manifolds in such a way that the openings on the port operating ring are revolving between the respective openings on the fixed circular ring and that on the manifolds. It can be seen from FIG. 13 and FIG. 14, that for the configurations 1 and 2, port operating rings can be designed to be placed inside the respective fixed circular ring in such a way that the openings on the respective port operating ring revolve between the respective openings on the revolving assemblies and that on the fixed circular ring. The respective schematic port operating rings are represented by 73 in FIG. 13 for configuration 1 and 74 in FIG. 14 for configuration 2. Openings 75 and 76 in FIG. 13 and openings 77 and 78 in FIG. 14 are the intake and exhaust openings respectively on the respective port operating rings. Openings 79 and 80 in FIG. 13 and openings 81 and 82 in FIG. 14 are the respective openings for intake and exhaust on fixed circular rings 83 and 84 respectively. Intake and exhaust manifolds are represented by 85 and 86 in FIG. 13 and by 87 and 88 in FIG. 14 for configurations 1 and 2 respectively. It can be seen from the FIG. 13 and FIG. 14 that for such arrangement of the port operating ring, common openings can be provided for intake and exhaust on the fixed circular ring and on the respective manifolds.

For both configurations 1 and 2, the manifolds and the fixed circular rings are designed is such a way that they provide proper sealing and proper support to the respective port operating rings. The openings for intake and for exhaust on all the components are arranged in such a way that any of the exhaust openings never come within the zones of any of the intake openings during the operation of the revolving piston device. In a typical arrangement for the openings, if all the respective openings for intake and for exhaust are aligned to two separate parallel planes that are normal to the common axis and are located at sufficient distance from each other, none of the intake openings can come within the zone of any of the exhaust opening and vice versa during the operation of the revolving piston device.

Placing the port operating ring inside the fixed circular ring as shown in FIG. 13 and FIG. 14 can give better performance of the CAV as it does not get connected to large openings on the fixed circular ring as in FIG. 1 and FIG. 5 when the respective passages are blocked or when the respective passages are begin to open. To avoid unnecessary increase in the CAV when it comes in contact with the openings on the fixed circular ring or on the port operating ring, appropriate multiple openings can also be provided for intake and exhaust passages respectively, on the revolving assemblies, or on the fixed circular ring, or on the port operating ring, or on respective manifolds or on few of them or on all of the them.

It is possible to couple a port operating ring to any of the revolving components of the revolving piston device with appropriate speed ratio between them and with appropriate openings on all the related components, including the port operating ring itself, of the revolving piston device. Two separate port operating rings can also be used as one each for individual intake and exhaust passages and can be coupled to two different revolving components of the revolving piston device. For the arrangement where separate port operating rings for intake and exhaust passages are used a combination of the port operating rings with one inside and one outside the fixed circular ring can also be used.

For explaining the function of the port operating ring, the speed ratio between the port operating ring and the respective elliptical gear is taken as 1:2 for both the configurations 1 and 2, in actual practice the speed ratio between the port operating ring and the respective elliptical gear need not necessarily be 1:2. The respective locations and zones for openings for the intake and exhaust passages, on revolving assemblies, on fixed circular ring, on port operating ring and on the manifolds are different for configurations 1 and 2. Actual openings on individual components can be different from the one shown in the drawings as the respective openings depend on, specific design requirements, number of piston pairs associated with a fixed circular ring, RSR value for the configuration, type of profile generator used, single or multiple port operating rings used, revolving component to which the individual port operating ring is coupled, speed ratio between the port operating ring and the coupled component of the revolving piston device, use of valves for the purpose of controlling the intake and exhaust passages, use of valves in combination with the port operating ring and many more factors.

It is advisable to couple the port operating ring or other additional revolving components, for example the flywheel, to a revolving member of the revolving piston device that has less fluctuation in its operational angular speed. Functionally coupling the components to any appropriate revolving member of the revolving piston device makes no difference as all are coupled to each other through positive drive trains and are synchronized with each other.

Maximum RSR: Consider a revolving piston device with one revolving piston pair associated with the fixed circular ring, with the identical pitch ellipses for the elliptical gears of the profile generator having semi major axis length as 40 units and semi minor axis length as 37 units, eccentricity is approximately 0.38. Theoretical angle of separation between leading and trailing pistons at BDC, considering zero clearance is given by

RSR*{(angle28+angle33)−(angle29+angle34)}

Thus the theoretical angle of separation between leading and trailing pistons for RSR as 4 is

4*{(112.33+112.33)−(67.67+67.67)}=357(approximate)degrees

And the theoretical angle of separation between leading and trailing pistons for RSR as 5 is

5*{(112.33+112.33)−(67.67+67.67)}=447(approximate)degrees

The theoretical angle of separation between leading and trailing pistons can not be more than 360° as to avoid the leading piston hitting the trailing piston and locking further movement of the leading piston. As angle of separation is more than 360 degree at RSR as 5 and above. The maximum theoretical RSR possible is 4 for the considered configuration that gives the 357 degrees of theoretical angle of separation between the leading and trailing pistons at BDC.

Thus maximum obtainable RSR increases with reduction in eccentricity of the elliptical gears of the profile generator or with reduction in absolute maximum instantaneous speed ratio between two cranks of the profile generator, as the case may be. Also maximum obtainable RSR decreases with increase in number of revolving piston pairs associated with one fixed circular ring. Thus it is always recommended that a proper combination of eccentricity of the pitch ellipses, or ratio of the link lengths of the double crank mechanism for the specific profile generator used, number of revolving piston pairs associated with the fixed circular ring and the RSR value, should be used for optimum performance of the revolving piston device.

### Use of Double Crank Mechanism as Relative Speed Profile Generator:

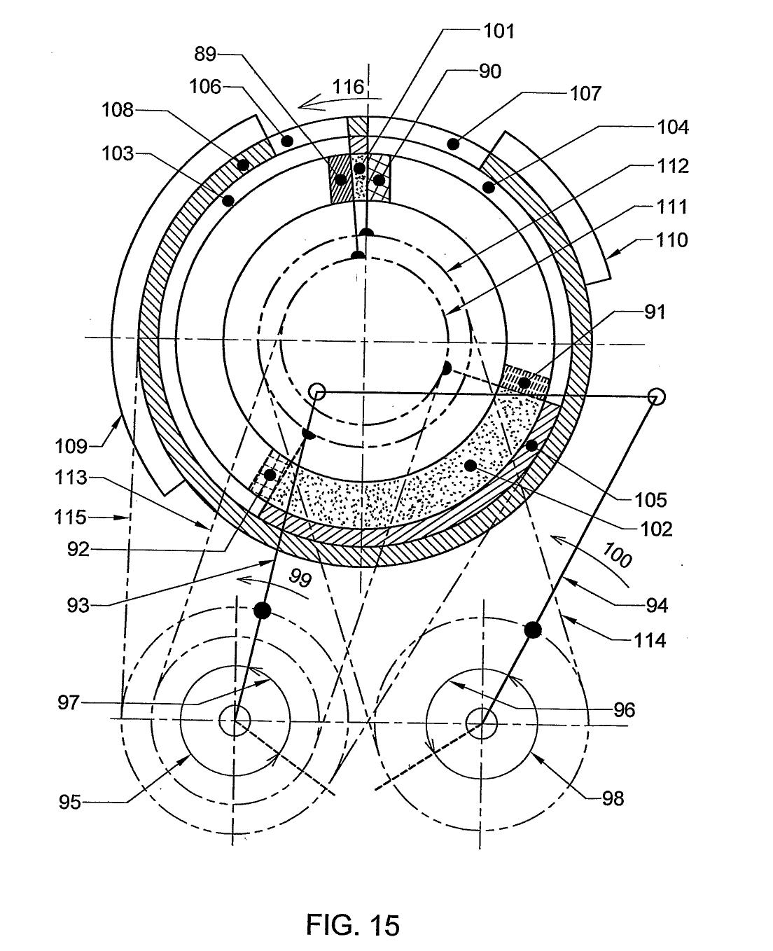

In the descriptions till now, mainly two meshing elliptical gears were used as the profile generator, just for an example a schematic revolving piston device with single revolving piston pair associated with one fixed circular ring and RSR as 1 is shown in FIG. 15 that uses a typical double crank mechanism as the profile generator. FIG. 15 also shows a single port operating ring with the openings on it revolving between the respective openings on the fixed circular ring and that on the manifolds, leading piston 89 and trailing piston 90 at TDC with the two cranks having instantaneous angular speed ratio of 1:1 between them. At the end of travel of the piston pair from TDC to BDC the new positions of the two pistons at BDC are shown in dotted lines by 91 and 92 respectively, the two cranks corresponding to BDC also have instantaneous angular speed ratio of 1:1 between them. The leading crank 93 and the trailing crank 94 are coupled to the leading and trailing pistons respectively in such a way that the revolving pistons revolve in the same direction and have instantaneous speed of revolution as that of the coupled crank respectively. For the travel of revolving piston pair from TDC to BDC the leading crank rotates by an angle 95 and correspondingly the trailing crank rotates by an angle 96. For the travel of piston pair from BDC to TDC the corresponding angles of rotation of the leading and trailing cranks are 97 and 98 respectively. The two cranks 93 and 94 are revolving in the directions 99 and 100 respectively. The clearance volume i.e. the CAV at TDC is represented by 101 and at BDC is represented by 102. Intake and exhaust openings are represented by 103 and 104 on the fixed circular ring 105 and by 106 and 107 on port operating ring 108 respectively. Zones for intake and exhaust manifolds are represented by 109 and 110 respectively. The leading piston 89 is a portion of the revolving assembly 111 and the trailing piston 90 is a portion of the revolving assembly 112. The two revolving assemblies are coupled to the two cranks 93 and 94 by the positive drive trains 113 and 114 respectively. The port operating ring 108 is coupled through a positive drive train 115 to the leading crank 93 in such a way that it revolves in the direction 116 of the two revolving assemblies and has instantaneous speed ratio of 1:2 with the crank.

The extent of individual openings on different components of the revolving piston device, and the functioning of the revolving piston device with double crank mechanism used as a profile generator for different RSR values, can be easily understood, on the lines of description for the respective configurations considered before using two elliptical gears as the profile generator, for the respective positions of the piston pair at TDC and BDC, thus the detailed description for the present configuration of a revolving piston device is not included here.

### Calculation for the Compression Ratio:

In FIG. 1 with RSR as 1 and eccentricity of the pitch ellipse as approximately 0.38, the volume between revolving pistons 4 and 5 at TDC is considered as the clearance volume analogous to a reciprocating piston device. The swept volume by leading piston from position 4 to position 30 is proportional to the swept angle of leading piston from TDC to BDC; the swept volume of trailing piston from position 5 to position 31 is proportional to corresponding swept angle of trailing piston from TDC to BDC. The swept volume of CAV is swept volume of leading piston minus that of trailing piston from TDC to BDC and that is proportional to the difference in corresponding swept angles. The clearance volume is proportional to the clearance angle i.e. the angle between the inner faces, which are assumed to be radial, of the pistons 4 and 5 at TDC. The compression ratio is the ratio of CAV at BDC to that at TDC. The CAV at TDC is the clearance volume and that at BDC is the swept volume of CAV plus clearance volume. Thus the compression ratio (CR) for Configuration 1 with RSR as 1 is the ratio of difference in swept angle of the two pistons plus the clearance angle to the clearance angle i.e.

CR={(angle28+angle33)−(angle29+angle34)+clearance angle}/clearance angle

Thus for clearance angle of 5 degrees

CR={(112.33+112.33)−(67.67+67.67)+5}/5=18.86(approximate)

For clearance angle of 10 degrees

CR={(112.33+112.33)−(67.67+67.67)+10}/10=9.93(approximate)

The above values of CR for Configuration 2 for RSR as 2, will be For clearance angle of 5 degrees

CR=[2*{(112.33+112.33)−(67.67+67.67)}+5]/5=36.73(approximate)

For clearance angle of 10 degrees

CR=[2*{(112.33+112.33)−(67.67+67.67)}+10]/10=18.86(approximate)

Thus it can be seen that CR increases with reduction in the clearance angle also it increases with increase in RSR and vice versa. The CR depends on the angles 28, 33, 29 and 34 and these angles depend on the eccentricity of the pitch ellipse used for the profile generator. Thus it can be seen that lower the eccentricity of pitch ellipses, lesser is the CR obtained. Similarly by lowering the maximum absolute instantaneous speed ratio between the two cranks of a profile generator using double crank mechanism, the CR can be reduced.

### Two Stroke Revolving Piston Internal Combustion Engine:

Consider a revolving piston device with RSR as 1 and having single revolving piston pair with appropriate port operating ring. The revolving piston device is very suitable to be used as a two stroke engine with few modifications and by appropriately utilising the travel of the revolving piston pair from BDC to TDC by part for exhaust, for intake and for compression processes or in other words by shortening and overlapping the exhaust process and intake process so that both are over within a short travel of piston pair from BDC to TDC and then utilising the rest of the travel for the compression process. Profile generator that has two elliptical gears in mesh is assumed for explanation. During the travel of the piston pair from BDC to TDC, exhaust process is started near BDC followed by the start of intake process after a short travel of the piston pair, intake process ends after short travel of piston pair from the end of the exhaust process, the compression process starts immediately after the end of intake process and continues till the piston pair reaches TDC. The openings for the intake and exhaust passages on various components can be arranged in such a way that start of the intake can force the gases in CAV towards exhaust passage. By appropriately igniting the contents of CAV near TDC we can get a power stroke during the expansion phase of the revolution of the elliptical gear in other words during the travel of the piston pair from TDC to BDC. Thus we can get one power stroke for every revolution of the elliptical gear or every revolution of the revolving piston pair or for every cycle of one expansion phase and one compression phase for the revolving piston pair.

We can get advantage of revolving CAV to identify suitable zones on the fixed circular ring for start of exhaust, start of intake, end of exhaust, and end of intake and accordingly we can design the openings for fixed circular ring, respective manifolds, the two revolving assemblies, and the port operating ring. For this case the port operating ring has to complete one revolution for every revolution of the elliptical gear as all the four strokes, although overlapped for some portion, are executed within one revolution of the elliptical gear. Proper design of the revolving assemblies and the fixed circular ring with appropriate openings can eliminate the need of port operating ring for the configuration of internal combustion engine.

Thus we can even have two separate parameters for the engine as compression ratio, which is the ratio of the volume of CAV at the start of compression or at the end of intake to that at TDC or to the clearance volume, and the expansion ratio that is the ratio of CAV at BDC to that at the TDC or to the clearance volume. In this case the compression ratio will be less than the expansion ratio and thus we can reduce the pressure of the exhaust gases and thus increase the efficiency of the engine and also reduce the vibrations of the engine as compared to that with a revolving piston device that has expansion ratio equal to the compression ratio. This type of engine is very beneficial for the fuel injection type of engines as only air is taken in during the intake process and any loss of intake air that may occur during the overlapped exhaust process will not cause a loss of fuel.

Other versions of the revolving piston device with different RSR, with use of different profile generator, with use of different techniques for using port operating ring, having more number of piston pairs for one fixed circular ring, can also be used for making a two stroke internal combustion engine by appropriately using the description given above. An engine thus made will improved power to mass ratio.

Advantages of the Revolving Piston Device with Higher RSR:
1. It is easy to change the CR for a revolving piston device just by changing the clearance angle that can be done just by adjusting the alignment between the revolving assemblies and the revolving components of the profile generator this helps in making a variable CR engine; CR can also be changed by modifying RSR by modifying the positive drive train for the same size of the engine, thus tuning of the CR is also possible. A feature important in making a multi fuel engine.
2. This device is suitable for making engine for all types of fuels and different ignition methods those can be used in reciprocating piston engine. The combustion chamber can also be designed outside the fixed circular ring.
3. The revolving piston pair complete one or more revolutions for every revolution of the elliptical gears, thus the size of the engine can be made relatively small.
4. The passages for intake and exhaust are closed and opened with yet another revolving ring instead of valves to operate; this makes the engine more robust.
5. While combustion takes place and while product of combustion and the CAV expands, the piston pair revolves; thus creating a revolving heat source for easy and efficient cooling and providing more surface area available for cooling.
6. Large portion of the fixed circular ring is available making it suitable for easy cooling by liquid coolant or by any other cooling method.
7. Use of multiple revolving piston pairs for the same fixed circular ring can allow higher power generation for approximately same physical size of the engine. This also allows higher power to weight ratio obtainable with less modification.
8. Vibration levels are low as the reciprocating parts are absent, that can be further reduced by use of multiple revolving piston pairs to balance each other.
9. Reduced speed of components of profile generator and the port operating ring adds to reduce vibrations in the revolving piston device; it also allows increase in the operational speed of the revolving piston device.
10. The engine thus made can be used as an engine module that can be put together in parallel with a common output shaft to increase power output.
11. Multiple engines can be used at a time with a common output shaft to make an equivalent of multi-cylinder reciprocating piston engine. Engine or part of engine can be designed for interchangeability and thus making it possible to keep it as a spare and use it to replace a faulty one in emergency with ease and with minimum down time. It is possible to change the power output by engaging or disengaging a particular engine with the common output shaft.
12. While using multiple engines, different engines can be arranged on a common output shaft such that a power stroke in one engine overlap compression stroke in other engine, for obtaining smooth power output and thus possibly reducing the size of the flywheel.
13. Space between pistons of different revolving piston pairs can be used for pre-compression of the air or air fuel mixture for supplying it to the CAV appropriately at the beginning of compression stroke. This can be used to increase the output power as in super charging of the engine.
14. An engine can be designed to have less down time while repairing, because of less number of parts a compact and cost effective engine can be made.
15. The engines' expected life is longer as it has no reciprocating part and very effective cooling is possible. The engine heating is less because of revolving heat source CAV. As the revolving pistons are fixed to the revolving assemblies and have no relative movement with respect to the respective revolving assembly, sealing can be easy.
16. It is possible to mount spark plug on to the piston itself to have better control on ignition timing and thus eliminating the need of separate combustion chamber.
17. A two stroke internal combustion engine can be made with revolving piston device by suitably utilising the travel of the piston pair from BDC to TDC, for exhaust, intake, and then compression processes. The travel of piston pair from TDC to BDC is used for power stroke.
18. It is very easy to use this principle to develop a revolving piston compressor or a steam engine for that the openings on different components are to be appropriately designed and relocated. In such applications the expansion phase of the CAV is used as intake stroke for compressor and power stroke for steam engine and compression phase of CAV is used as outlet for both.
19. Proper selection of the ratios of the lengths of the links used for double crank mechanism can allow a wide selection in the shape of the relative speed profile. Thus a revolving piston device with fast compression and slow expansion or vice versa can be made for specific applications.

### Disadvantages of the Revolving Piston Engine:

1. As many revolving components are coming in contact with CAV which itself is revolving, proper sealing is not very simple.
2. Gear wearing out or the wearing out of the pins of the double crank mechanism may affect the performance of the engine.
3. Openings on the fixed circular ring or the port operating ring come in contact with CAV even when the respective passage is closed, this may affect the performance of the revolving piston device. Multiple openings instead of single openings for the same passage can provide better performance.
4. When the port operating ring is placed inside the fixed circular ring, presence of more revolving components within CAV can pose difficulty in proper sealing.

1. A revolving piston device, comprising at least one fixed circular ring, at least one piston pair that revolves around an axis of the fixed circular ring, at least one port operating ring that revolves around an axis of the fixed circular ring,
wherein one piston of the piston pair is a portion of a first revolving assembly and the other piston of the piston pair is a portion of a second revolving assembly, the space between the two pistons of the piston pair acts as controlled active volume,
wherein the two revolving assemblies and thus the pistons as portions of it, revolve with relative angular speed profile wherein this relatively varying angular speed of the pistons of piston pair causes expansion and compression of the controlled active volume,
wherein one of the two revolving assemblies drives the other through positive drive train that includes a relative speed profile generator that decides relative angular speed profile of one revolving assembly with respect to the other and revolve both the revolving assemblies in same direction,
wherein the relative speed profile generator is mounted on fixed axes and consists of a four bar linkage that operates as a double crank mechanism or consists of two elliptical gears in mesh, with their fixed axes of rotation passing through one of their respective geometric focus points, wherein the distance between the axes of rotation of the elliptical gears is equal to the length of major axis of the pitch ellipse and the elliptical gears have same pitch ellipses,
wherein an output shaft is coupled to one of the two revolving assemblies,
characterized in that,
the controlled active volume completes one cycle consisting of one expansion phase and one compression phase within one or more than one revolution of one of the revolving assemblies;
individual port operating ring is coupled to one of the revolving assemblies as to open and close the passage between controlled active volume and respective exhaust and intake manifolds as to control the flow of substance between respective manifolds and the controlled active volume;
opening and closing of individual passage between respective manifolds and controlled active volume is synchronized with revolution of respective revolving assemblies.

2. A revolving piston device as in claim 1, that utilises valves or combination of valves and port operating ring in place of the port operating ring for closing and opening of the individual passages between the controlled active volume and the respective intake and exhaust manifolds.

3. A revolving piston device as claimed in claims 1 or 2 that is used as a variable compression ratio device by allowing change in the clearance volume by changing the minimum separation between the pistons of revolving piston pair.

4. A revolving piston device as claimed in any of the claims 1 to 3 wherein more than one piston pairs are associated with a fixed circular ring.

5. A revolving piston device as claimed in any of the claims 1 to 4 that has a double crank mechanism working as relative speed profile generator and has unequal revolutions of controlled active volume for its compression phase and expansion phase respectively, or has slow expansion and fast compression or vice versa.

6. A revolving piston device as claimed in any of the claims 1 to 5, which is used to make a revolving piston internal combustion engine, wherein controlled active volume receives air or air fuel mixture during one expansion phase as an intake stroke, and compress it during next compression phase as a compression stroke; wherein fuel is ignited when the piston pair is near to the end of compression phase and the contents of controlled active volume expand during next expansion phase giving a power stroke, and further exhaust of contents of controlled active volume takes place during next compression phase as exhaust stroke; wherein the passage for intake to controlled active volume is suitably opened for respective travel of the piston pair during intake stroke and the passage for exhaust from controlled active volume is suitably opened during the exhaust stroke respectively; combustion of fuel may take place within the controlled active volume or in a specially designed combustion chamber out side the controlled active volume.

7. A revolving piston device as claimed in any of the claims 1 to 5, which is used to make an equivalent of two stroke revolving piston internal combustion engine by utilising compression phase of controlled active volume, by parts, for exhaust process, for intake process, and for compression process, by shortening and overlapping exhaust process and intake process so that both are over within a short travel of piston pair from BDC to TDC and then utilising rest of the compression phase for compression process; by appropriately igniting the contents of controlled active volume near the end of compression phase, a power stroke is obtained during expansion phase of controlled active volume.

8. An engine as claimed in claims 6 or 7, wherein, for a revolving piston internal combustion engine with one revolving piston pair associated with a fixed circular ring, the outer space between pistons of a piston pair that is not the controlled active volume, or for a revolving piston internal combustion engine with more than one revolving piston pairs associated with a fixed circular ring, the space between pistons of two different piston pairs is used for the purpose of pre-compression of air or air fuel mixture.

9. An engine as claimed in any of the claims 6 to 8, in which a spark plug is fitted on to one of the pistons of the piston pair.

10. An engine as claimed in any of the claims 6 to 9 that has a flywheel and output shaft connected to one of the revolving assemblies.

11. An engine arrangement comprising of two or more of the engines according to any of the claims 6 to 10 in parallel, with a common output shaft.

12. An engine arrangement according to claim 11, wherein engines are arranged in such a way that a power stroke in one engine overlaps with a compression stroke in another engine or the engines are arranged in such a way that the power strokes in different engines take place at different timings.

13. An engine arrangement according to claims 11 or 12, wherein engines or part of engines, are provided as separate modules and engine fittings are designed for interchangeability to allow use of a single separate module as a spare for replacement of a faulty module out of the engine arrangement.

14. An engine arrangement according to claims 11 to 13 wherein a particular engine can be connected to or disconnected from the output shaft as to change the power out put at the output shaft.

15. A revolving piston device according to any of the claims 1 to 5, that is used to form a revolving piston compressor by utilizing expansion phase of controlled active volume, as intake stroke and delivering compressed gases at the end of compression phase of controlled active volume appropriately; the output shaft is used to get the mechanical power input to the compressor.

16. A compressor comprising of two or more of the revolving piston compressors according to claim 15 are arranged, in series, or in parallel, respectively.

17. A revolving piston device according to any of the claims 1 to 5, that is used to form a steam engine or a hydraulic pump.
